(19) United States
(12) Patent Application Publication
(10) Pub. No.: US 2015/0120494 A1
(43) Pub. Date: Apr. 30, 2015

(54) ELECTRONIC COMMERCE PROMOTIONS PREVIEW

(71) Applicant: Oracle International Corporation, Redwood Shores, CA (US)

(72) Inventors: Kristen J. FLANAGAN, Brighton, MA (US); Reed OSBORNE, BOSTON, MA (US); Shari SYKES, Hingham, MA (US)

(21) Appl. No.: 14/062,082

(22) Filed: Oct. 24, 2013

(51) Int. Cl. G06Q 30/06

(52) U.S. Cl. CPC G06Q 30/0633
USPC 705/26.8

(57) ABSTRACT

An e-commerce system provides a preview of promotions available on an e-commerce web site. While in a preview mode, the system allows a business user to select one or more items and add them to a shopping cart. The system then determines a count of the number of promotions that would be applied to the items in shopping cart. The system provides a promotions button in a user interface that displays the promotions count.

### FIELD

One embodiment is directed generally to a computer system, and in particular to a computer system that provides electronic commerce.

### BACKGROUND INFORMATION

Electronic commerce, or “e-commerce”, is generally considered the buying and selling of a product or service over electronic systems, or a “commerce network”, such as the Internet and other computer networks. Electronic commerce can include functionality such as mobile commerce, electronic funds transfer, supply chain management, Internet marketing, online transaction processing, electronic data interchange (“EDI”), inventory management systems, and automated data collection systems. Electronic commerce and a commerce network as a core function provides the exchange of data to facilitate the financing and payment aspects of business transactions. Further, a commerce network that accommodates many different types of payments accumulates data that can provide useful analytical information.

An e-commerce web site or storefront typically provides a catalog of available items for purchase, prices for the products, and infrastructure for supporting purchases including a shopping cart and payment mechanism. Because prices are represented electronically, they can easily be modified. Some e-commerce retailers frequently modify catalog prices in reaction to changing market conditions and competitive pricing, frequently run price promotions and are constantly fine-tuning how and where items and offers are presented in order to keep customers engaged.

### SUMMARY

One embodiment is an e-commerce system that provides a preview of promotions available on an e-commerce web site. While in a preview mode, the system allows a business user to select one or more items and add them to a shopping cart. The system then determines a count of the number of promotions that would be applied to the items in shopping cart. The system provides a promotions button in a user interface that displays the promotions count.

### BRIEF DESCRIPTION OF THE DRAWINGS

FIG. 1 is a block diagram of a computer system that can implement an embodiment of the present invention.

FIG. 2 is a screenshot of a simulated shopping interaction of an e-commerce web site by a business user in accordance with one embodiment of the invention.

FIG. 3 is a screenshot showing an example of a message that is generated adjacent to a promotions button in accordance with one embodiment of the invention.

FIG. 4 is an example screenshot of a promotions visibility user interface in accordance with one embodiment.

FIG. 5 is a flow diagram of the functionality of the e-commerce promotion preview module of FIG. 1 when providing previews of promotions in accordance with one embodiment.

### DETAILED DESCRIPTION

One embodiment is an electronic commerce system that allows a business user to create promotions (i.e., discounts that can be applied to a customer's order or account). Once the promotion is created in the system, a business user is able to select a “promotions” button in a preview mode that allows the business user to see how and when promotions are applied to a customer's shopping cart. Embodiments provide the business user with insight to the promotions that have been set up and what promotions an end user/customer would qualify for, and allow the business user to troubleshoot the selected promotions before they go “live” or into “production”.

A typical e-commerce web site at any given point may offer hundreds of promotions. Any particular product, or shopping cart of products, may qualify for one or more of the promotions, and the promotions for that product or shopping cart may be stacked so that multiple promotions apply to a single purchase, or only a single one of the multiple promotions (i.e., the promotion that provides the biggest discount/benefit) may be applied to a purchase. In one embodiment, the available promotions can be divided into the following types:
Item Discount Promotions: The customer receives a discount on an item or items.
Order Discount Promotions: The customer receives a discount to an entire order (i.e., shopping cart).
Shipping Discount Promotions: The customer receives discounted shipping.

Each promotion may be “delivered” to the users through various methods. For example, a coupon or batch of coupons can be created that grant the promotion to a user profile. Further, a scenario can be set up that determines the visitors who qualify for the promotion. Promotions can also be provided to all customers automatically—for these, there is no need to set up a scenario or a coupon. In one embodiment, any promotion that a customer qualifies for is entered in the customer's user profile. When the customer adds an item to their cart or performs any other action that involves requesting a price from the system, the e-commerce system can check their user profile to see whether they currently qualify to receive any of the promotions. If a customer qualifies, the system uses the promotion discounts to calculate the price of the product for the customer, and adjusts the price accordingly.

With all the possible promotions available, the business users of e-commerce web sites (i.e., the users who create promotions, change prices, etc., before pushing the changes to the production web site) have the need to understand how a promotion will behave when deployed and how other promotions affect the behavior of a given promotion. Known methods for understanding how promotions behave on an e-commerce web site include having the business user interacting with the live production web site as a “shopper” and selecting items to add to a shopping cart, and then seeing which promotions apply. However, because this requires the promotions to go live into production, any detected problems can impact actual purchases by users. In contrast, embodiments of the present invention allow the business user to preview the promotions before the promotions go into production.

In one embodiment, business users can see if they have set up a promotion incorrectly. Specifically, the business user may check to see if the promotion and discounting behavior in a preview mode site matches their expectations. For example, a shopper should receive free shipping on all orders over $100. Once the business user creates that shipping promotion in the system, she can use the preview mode and add $120 worth of items to her cart. Her expectation is that the shopper would qualify for free shipping. If the business user does not see that behavior on the preview site, she can select a promotions button, which will show her the promotions that are applied, the qualifying actions for the promotions, and other important information. With that information, the business user is able to go back into the system and make changes to the promotion so that the expected behavior will happen. In one embodiment, the business user is able to troubleshoot behavior for the promotion compatibility rules, exclusions, maximum limits, usage dates, valid promotion qualifiers, target items, etc., in the shopper's cart.

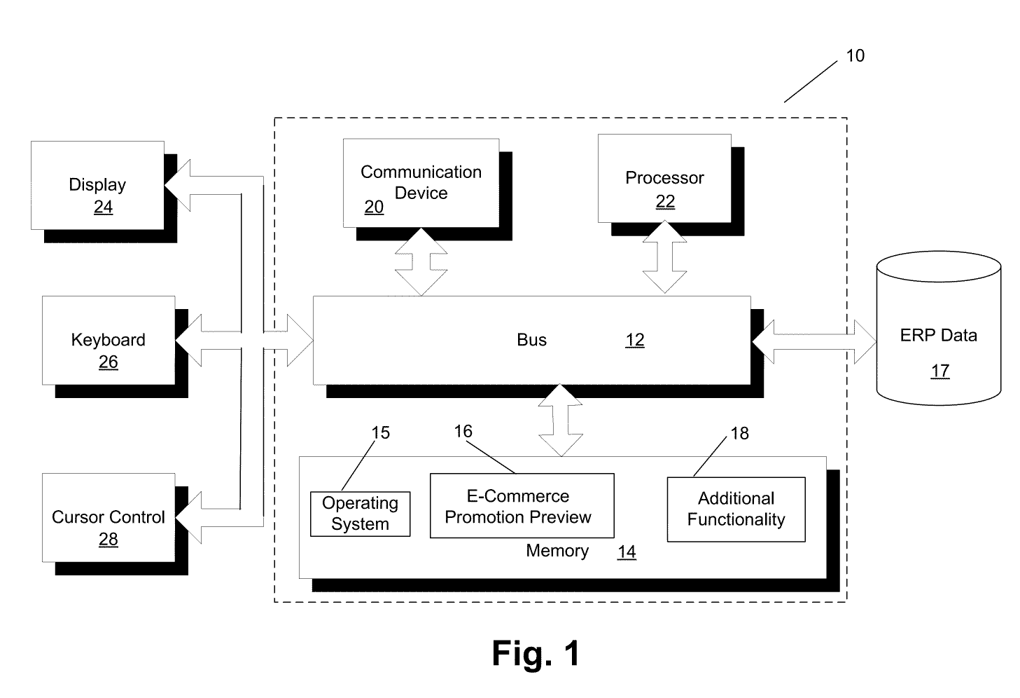

FIG. 1 is a block diagram of a computer system 10 that can implement an embodiment of the present invention. Although shown as a single system, the functionality of system 10 can be implemented as a distributed system. Further, embodiments do not need to include all elements shown in FIG. 1.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method. In one embodiment, the user of system 10 would be a business user/person responsible for creating promotions on an e-commerce web site or sites or any other type of content administration (“CA”).

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with system 10.

In one embodiment, memory 14 stores software modules that provide functionality when executed by processor 22. The modules include an operating system 15 that provides operating system functionality for system 10. The modules further include an e-commerce promotion preview module 16 that provides e-commerce promotion previewing, as disclosed in more detail below. System 10 can be part of a larger system, such as “Oracle ATG Web Commerce” from Oracle Corp. or an enterprise resource planning (“ERP”) system. Therefore, system 10 will typically include one or more additional functional modules 18 to include the additional functionality. A database 17 is coupled to bus 12 to provide centralized storage for modules 16 and 18 and store pricing information, inventory information, ERP data, etc.

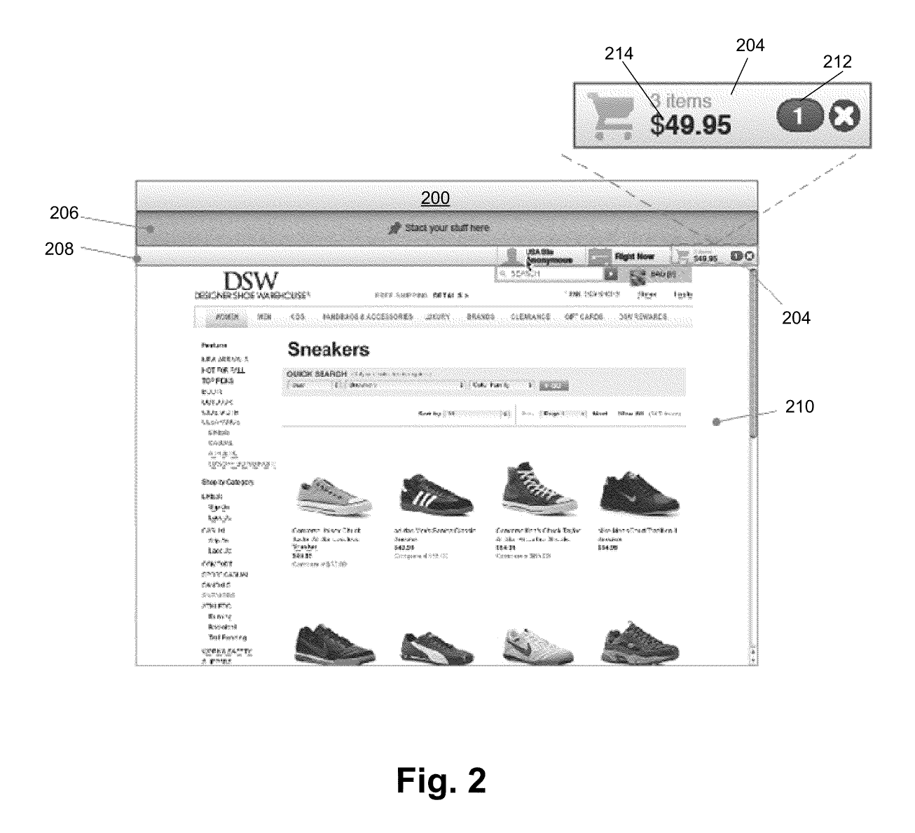

One embodiment generates a real-time promotions button as the business user “simulates” shopping on a non-production version of an e-commerce web site to provide details on promotions. FIG. 2 is a screenshot 200 of a simulated shopping interaction of an e-commerce web site by a business user in accordance with one embodiment of the invention. Screenshot 200 includes a preview pane 210 that displays items for purchase, a workbench 206 and a toolbar 208. Included on toolbar 208 is a promotions button 204. Promotions button 204 includes a running count and dollar total 210 of the items that have been placed in the shopping cart during the simulated shopping session. Button 204 further includes a promotions count 212 which is a count of the number of promotions that have been applied to the cart. In one embodiment, “applied” promotions are promotions that are enabled, active (not expired) and are valid on the site that the user is currently browsing and the “Condition/Offer” evaluation has passed.

Within the system, in one embodiment promotions have two major components: the “Condition” and the “Offer.” The Condition is the set of criteria that must be met in order for the customer to qualify for the promotion. For example, a business user sets up a “Buy One Get One” promotion so that if a customer buys one item in the “Shoes” category, she receives another item in the Shoes category at 25% off. The Condition is that the shopper must purchase an item from the shoes category in order to qualify for the promotion. The system assumes that the shopper, having placed an item from the Shoes category in the cart, has met this qualification. Next the system identifies a target item for applying the offer, which is 25% off of the next item purchased from the Shoes category. The system evaluates the items in the cart and filters out items that may not act as targets for the promotion offer. Reasons why an item may be filtered out from acting as a target may be that the item is non-discountable or has already served as a target for another promotion. Once that condition is met, the system grants her the Offer, which is 25% of the next item purchased in from the Shoes category.

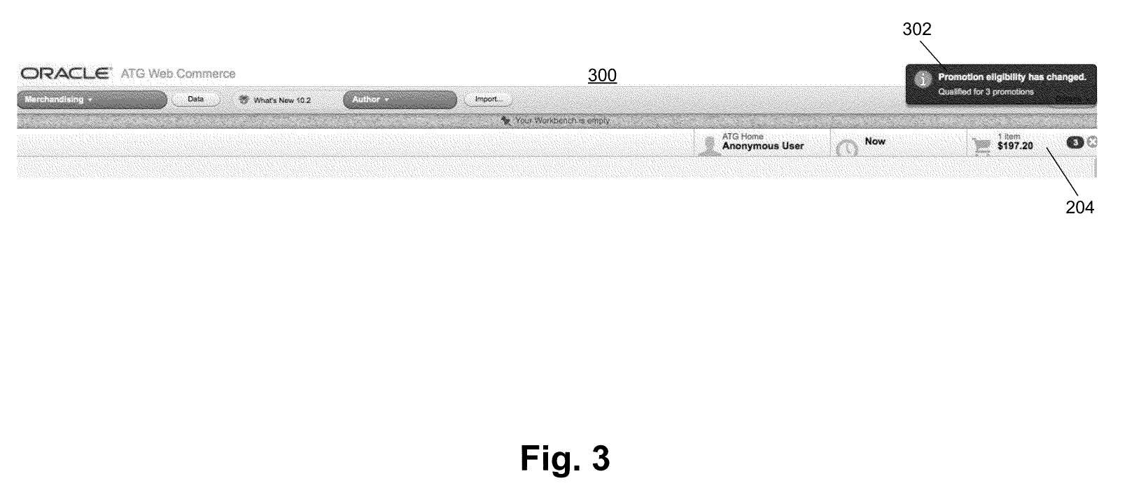

In addition to promotions button 204, one embodiment includes a message that is generated or pops up when a change in promotion eligibility has occurred. FIG. 3 is a screenshot 300 showing an example of a message 302 that is generated adjacent to promotions button 204 in accordance with one embodiment of the invention. Message 302 indicates that “promotion eligibility has changed” and provides the new number of qualified promotions. The number of qualified promotions is the same number that appears on promotions button 204.

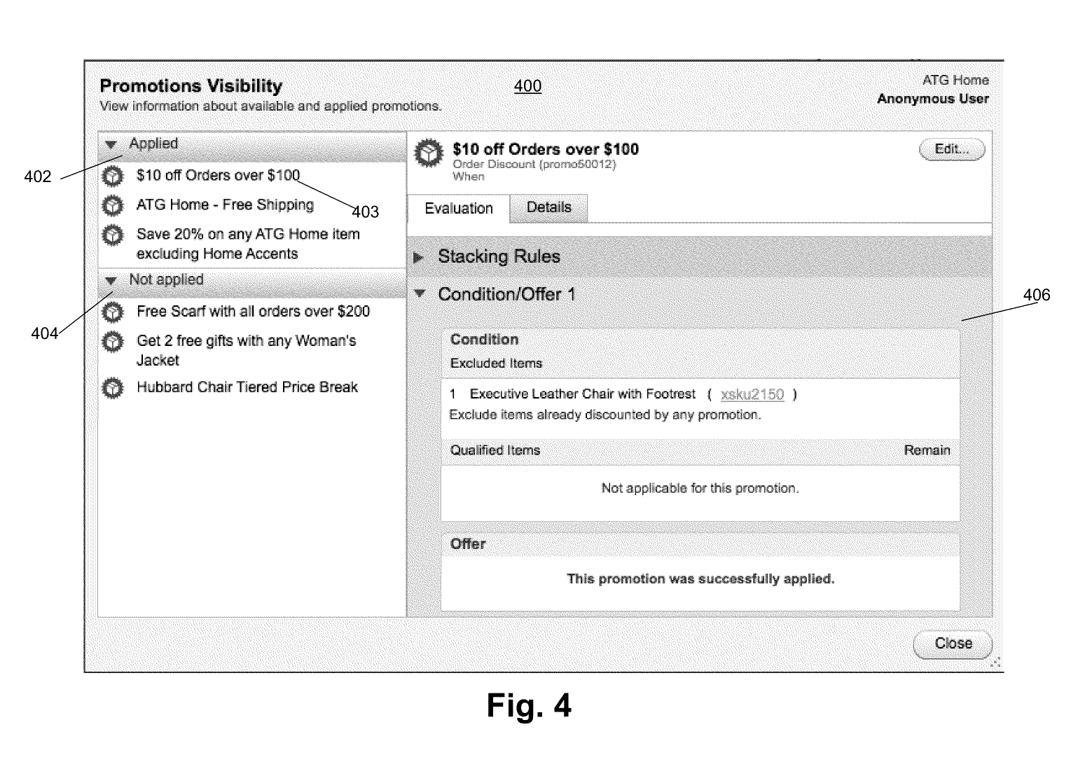

In one embodiment, a user can select or click on promotions button 204 to generate a promotions visibility user interface that provides information to the user about applied, not applied, and ineligible promotions in connection with the items in the shopping cart. FIG. 4 is an example screenshot 400 of a promotions visibility user interface in accordance with one embodiment. Screenshot 400 list the applied promotions in section 402 and the unapplied promotions in section 404, with a general description of each. The user can select any of these promotions, and section 406 displays how a promotions engine has evaluated the promotions and the items that are in the cart. Details about stacking rules, conditions, and offers are included to help business users review promotions and troubleshoot if they encounter a discount they were not expecting. Applied promotions are promotions that are applied to the cart. Not applied promotions are promotions that are enabled, active (not expired), and valid on the site that the user is currently browsing AND the Stacking Rule or Condition & Offer evaluation has not passed. Ineligible promotions (not shown in FIG. 4) are promotions that are enabled, active (not expired), and not valid on the site that the user is currently browsing.

For example, in FIG. 4, the first promotion in section 402 is selected (promotions 403). Section 406 indicates stacking rules and items that are excluded and the reasons for the exclusion. In one embodiment, stacking rules prevent customers from taking advantage of unintended synergy among promotions. By providing details of stacking rules that have been applied, the business user can adjust the promotions where applicable. For example, a business user can go into the “Promotions UI” and change the stacking rules or change other attributes of the promotion that will affect the way the system evaluates and applies the promotion. Therefore, if a user has set up a stacking rule that precludes two promotions from being applied in the same order, she can go into the UI and change that rule to allow those promotions to be applied in the same order.

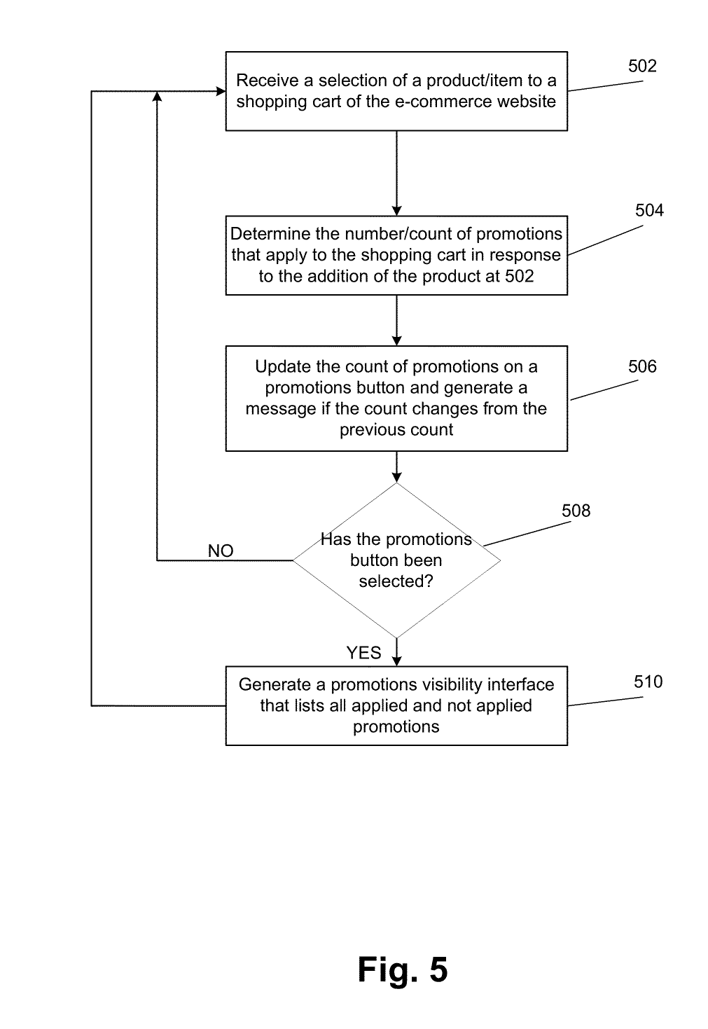

FIG. 5 is a flow diagram of the functionality of e-commerce promotion preview module 16 of FIG. 1 when providing previews of promotions in accordance with one embodiment. The functionality of FIG. 5 is performed while interacting with a non-production version of an e-commerce web site. In one embodiment, the functionality of the flow diagram of FIG. 5 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 502, a product/item is added to a shopping cart of the e-commerce website. The e-commerce web site includes a plurality of promotions, one or more of which may apply to a particular product or to the shopping cart.

At 504, module 16 determines the number/count of promotions that apply to the shopping cart in response to the addition of the product at 502.

At 506, module 16 updates the count of promotions on a promotions button and generates a message if the count changes from the previous count.

At 508, it is determined if the promotions button is selected.

If yes at 508, at 510 a promotions visibility interface is generated that lists all applied and not applied promotions, and provides details of any selected promotions. The details include stacking rules.

If no at 508, the functionality continues at 502.

As disclosed, embodiments provide visibility and details about the number and identity of promotions that are applied to a shopping cart of goods. Therefore, a business user that designs promotions and sets pricing for an e-commerce web site can troubleshoot and/or be aware of how the promotions interact with each other.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable medium having instructions stored thereon that, when executed by a processor, cause the processor to preview promotions of an e-commerce web site, the previewing comprising:
receiving a selection of an item for a shopping cart;
determining a count of a number of promotions applied to the shopping cart; and
updating a promotions button to indicate the count.

2. The computer readable medium of claim 1, the previewing comprising generating a message if the count has changed in response to receiving the selection.

3. The computer readable medium of claim 1, the previewing comprising:
generating a promotions visibility user interface for the shopping cart, the promotion visibility user interface comprising a listing of all promotions applied to the shopping cart.

4. The computer readable medium of claim 3, the promotion visibility user interface comprising a listing of all promotions not applied to the shopping cart.

5. The computer readable medium of claim 3, the previewing comprising:
receiving a selection of one of the applied promotions;
providing details on selected applied promotion, the details comprising stacking rules.

6. The computer readable medium of claim 5, the details further comprising a condition and an offer for the selected applied promotion.

7. The computer readable medium of claim 1, the promotions button further indicating a cumulative cost of all items in the shopping cart.

8. A method for previewing promotions of an e-commerce web site, the method comprising:
receiving a selection of an item for a shopping cart;
determining a count of a number of promotions applied to the shopping cart; and
updating a promotions button to indicate the count.

9. The method of claim 8, further comprising generating a message if the count has changed in response to receiving the selection.

10. The method of claim 8, further comprising:
generating a promotions visibility user interface for the shopping cart, the promotion visibility user interface comprising a listing of all promotions applied to the shopping cart.

11. The method of claim 10, the promotion visibility user interface comprising a listing of all promotions not applied to the shopping cart.

12. The method of claim 10, further comprising:
receiving a selection of one of the applied promotions; and
providing details on selected applied promotion, the details comprising stacking rules.

13. The method of claim 12, the details further comprising a condition and an offer for the selected applied promotion.

14. The method of claim 8, the promotions button further indicating a cumulative cost of all items in the shopping cart.

15. An e-commerce system comprising:
a processor coupled to a storage device that stores instructions to generate a preview user interface;
the preview user interface including preview functionality comprising:
receiving a selection of an item for a shopping cart;
determining a count of a number of promotions applied to the shopping cart; and
updating a promotions button displayed on the preview user interface to indicate the count.

16. The e-commerce system of claim 15, the preview functionality generating a message if the count has changed in response to receiving the selection.

17. The e-commerce system of claim 15, the preview functionality generating a promotions visibility user interface for the shopping cart, the promotion visibility user interface comprising a listing of all promotions applied to the shopping cart.

18. The e-commerce system of claim 17, the promotion visibility user interface comprising a listing of all promotions not applied to the shopping cart.

19. The e-commerce system of claim 17, the preview functionality comprising:
receiving a selection of one of the applied promotions; and
providing details on selected applied promotion, the details comprising stacking rules.

20. The e-commerce system of claim 15, the promotions button further indicating a cumulative cost of all items in the shopping cart.
